(19) United States
(12) Patent Application Publication
(10) Pub. No.: US 2010/0203490 A1
(43) Pub. Date: Aug. 12, 2010

(54) CHILDREN'S CLOCK

(76) Inventor: Adam B. Hocherman, Boston, MA (US)

Correspondence Address: FISH & RICHARDSON PC, P.O. BOX 1022, MINNEAPOLIS, MN, 55440-1022, US

(21) Appl. No.: 12/696,269

(22) Filed: Jan. 29, 2010

Related U.S. Application Data
(60) Provisional application No. 61/151,744, filed on Feb. 11, 2009.

(51) Int. Cl. G09B 19/12

(52) U.S. Cl. 434/304

(57) ABSTRACT

Among other things, a programmable timing device allows a user to control a state-changing lamp through a program sequence that permits assignment of an on time, an off time and, optionally, a state-change time, repeatable on a daily cycle.

### BACKGROUND

This application is entitled to the benefit of the filing date of U.S. provisional application Ser. 61/151,744, filed on 11 Feb. 2009, and incorporated here by reference.

This description relates to a children's clock.

Designs for children's clocks are many and the features and functions of such devices have been combined in numerous fashions. There are clocks which display the time, speak the time, or otherwise indicate visually a distinction between night and day. There are clocks which contain singular-purpose lights designed to cast a faint illumination into a dark room for the purposes of providing comfort.

### SUMMARY

In general, in an aspect, a visible indicator provides two or more effects that have a visible difference that can be understood by a child, and a controller causes the visible indicator to provide a selected one or more of the effects at corresponding times to indicate when it is appropriate for a child to take an action.

Implementations may include one or more of the following features. The visible indicator comprises a lamp that provides the two or more effects as two different colors of light. The action includes the child getting out of bed. The controller includes a clocking feature. The time measured by the clocking feature is displayed to the child as a clock. The difference includes a difference in color effect. The controller can be programmed independently with respect to each of the effects. The controller provides a time-teaching function. The time-teaching function teaches time represented in analog form or digital form or both. The controller provides a night-light function. The controller provides an alarm clock function. There are separate parent controls and child controls. The parent controls are concealed. There are interchangeable components to alter a physical appearance of the apparatus. There are elements that constitute the apparatus as a plush toy.

In general, in an aspect, a visible effect comprising one color of light from a lamp is displayed to a child who is in a bed, the one color of light being understood by the child as indicating that he should remain in the bed. At a time when it is appropriate for the child to get out of the bed, another visible effect comprising a different color of light from the lamp is displayed that is understood by the child as indicating that he may get out of the bed.

Implementations may include one or more of the following features. The two visible effects may be programmed by a user independently of one another. Time is taught to the child. The time is taught in either or both of an analog and a digital format. At least one of following is also done: (a) providing a night-light for the child, (b) providing an alarm, and (c) teaching time.

In general, in an aspect, a method includes enabling a user to program a lamp or light capable of displaying two or more different colored illuminations for purposes of visually indicating to a young child when it is appropriate to get out of bed by means of said lamp changing state. For example, the lamp could change from one color to another, change in intensity, toggle between on and off states, start or stop blinking, or otherwise change states in such a way as to provide a notification to the user. Programming of the lamp is designed to be easily accomplished by the user and may include the ability to turn said lamp on and/or off at one or more times of day but, specifically the programming of the lamp permits the user to select a specific time at which the lamp changes state for purposes of training young children to stay in bed. In at least one implementation the changing of state is accomplished by means of a color-changing lamp. While the lamp is a first color, the meaning is that the young child should remain in bed because it is not yet time to wake up. When the lamp changes to a second color, the meaning is that the time of day is now equal to or beyond the prescribed wake time and the child may rise and, perhaps, come see his or her parents in another room. Said first color of the lamp may be a color suitable for soft, nighttime illumination thereby allowing the lamp to be used as a nightlight. In at least one implementation the changing of state need not be implemented as a “transition” and, instead, the two states may be programmed independently of one another. In this way a first effect could be programmed to turn on at a given time and off at another and a second effect could be programmed to turn on at a different given time and off at another. The duration of these effects may or may not overlap with one another.

Implementations may include one or more of the following features. The color-changing lamp is a stand-alone programmable device. The color-changing lamp is combined with a digital or analog clock. The color-changing lamp is combined with a digital or analog clock which also contains an audible alarm mechanism. The color-changing lamp is combined with teaching functions such as games or lessons related to the telling of time on a digital and/or an analog-type clock. The color-changing lamp is combined with any number of other features that are common to the art such as multiple alarms, snooze functions, nap timers, audible speech announcements, record-playback reminder capabilities, or other such functions.

The programming of the device may take place via direct interaction with said device. For example, a series of buttons or knobs may be provided right on the device which allows the user to set, unset, or change the lamp programming by means of interaction with said controls. Review of related program information may be seen on a display mechanism such as a screen, series of labeled LEDs or another means of indicating the programmed settings. In another implementation, programming of the device may take place by means of an external connection to another device such as a personal computer, mobile phone, PDA, or other electronic device which contains its own means of input and display. Any number of other programming means may also achieve the same purpose—for example, the device may be programmed via voice recognition.

In some implementations, controls for the device may be separated into two distinct groupings, designed to be operated by two distinct classifications of users such as parents and children. Controls designated for the parents may, for example, be concealed behind a hatch, panel or door that may not be obvious to a child and/or that may be difficult for a child to access. Controls designated for the child would be more focally located, larger, fewer in number and/or easier to access and operate. Benefits of such an arrangement include making the device appear simple and friendly to a child while still allowing for more detailed control of advanced functions by the parent. Other classifications of users and/or arrangement of controls may be considered for other or similar purposes.

These and other aspects and features, and combinations of them, can be expressed as methods, apparatus, means for performing functions, systems, program products, and business methods, and in other ways.

Other advantages and features will become apparent from the description and the claims.

### DESCRIPTION

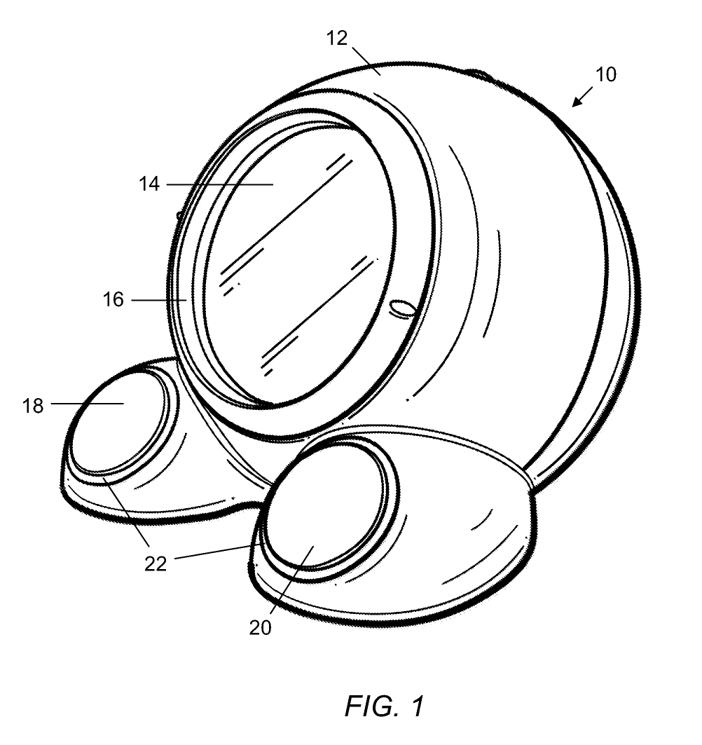

FIG. 1 is a front perspective view of a color-changing lamp.

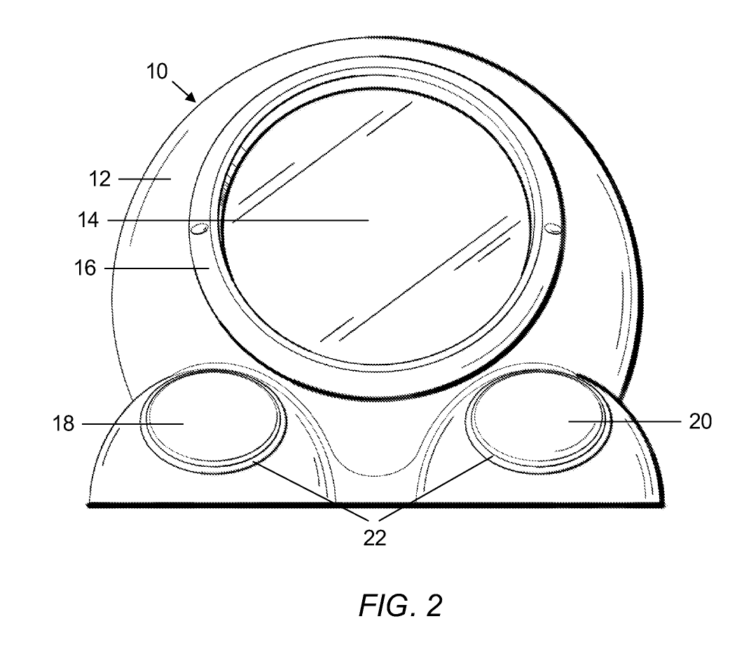

FIG. 2 is a front view of a color-changing lamp.

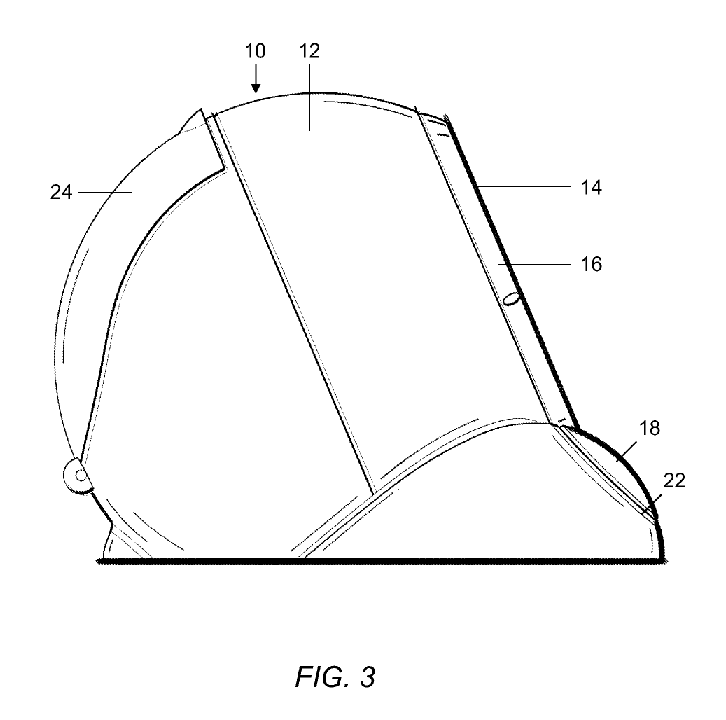

FIG. 3 is a side view of a color-changing lamp.

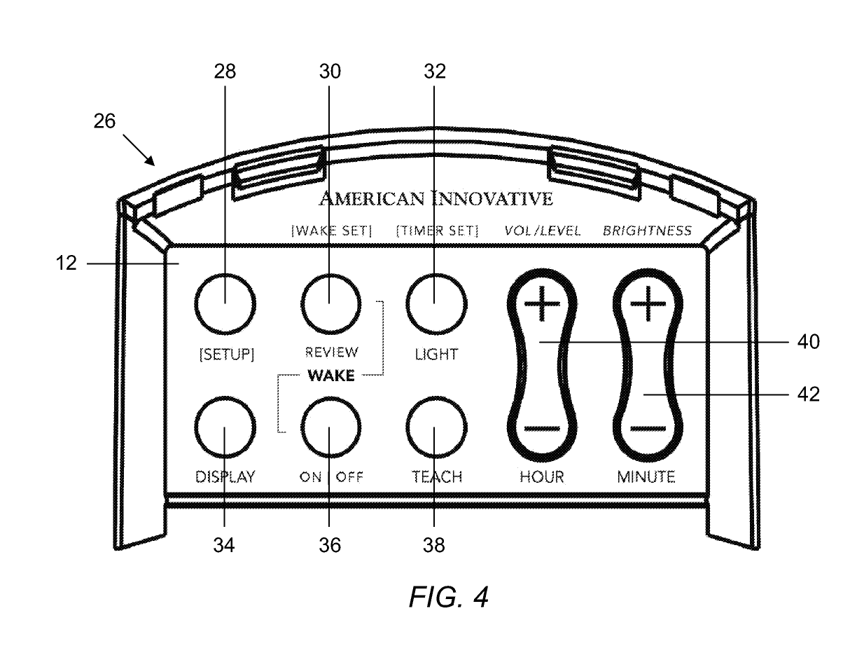

FIG. 4 is a view of a control panel.

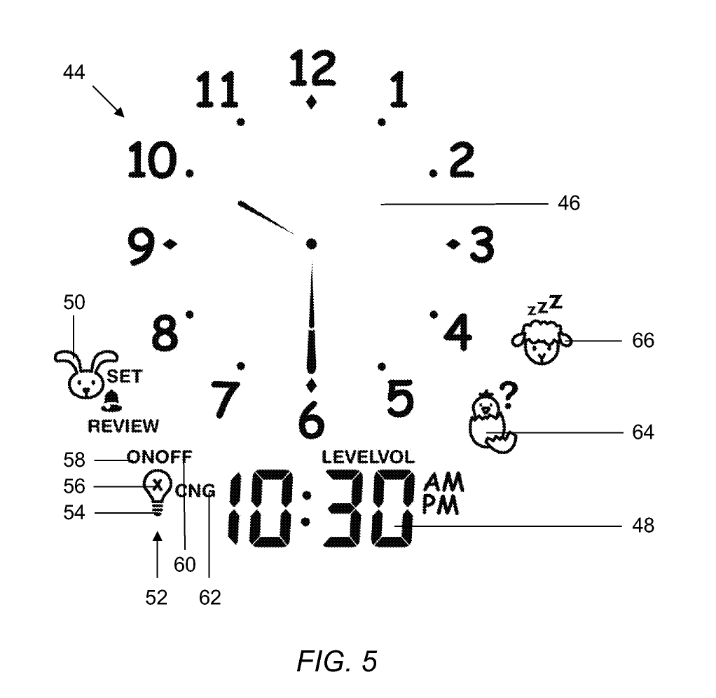

FIG. 5 is a view of an LCD display.

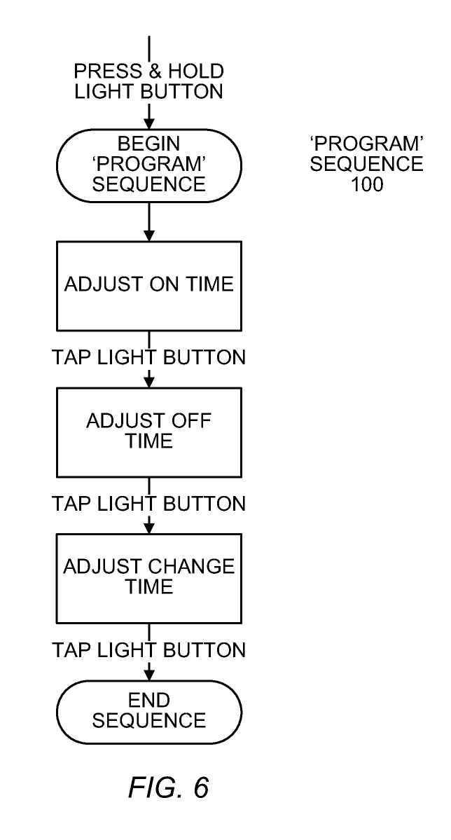

FIG. 6 is a flowchart.

As shown in the example implementation depicted in FIGS. 1-3, a children's clock 10 (an example of a “device” or “apparatus”), has a housing 12 containing a display region 14 located on the front side of the device. The front side of the device also contains a removable bezel 16, a left button 18 (as seen from the perspective of the user) and a right button 20 (also as seen from the perspective of the user). Illuminated bezels 22 surround said left and right buttons and may illuminate in one or more colors.

As shown in FIG. 3, a hatch 24 conceals a control panel 26, which is described in more detail in FIG. 4.

As shown in FIG. 4, an example control panel 26 includes a SETUP button 28, a REVIEW button 30, a LIGHT button 32, a DISPLAY button 34, an ON|OFF button 36, a TEACH button 38 an HOUR +/− button 40 and a MINUTE +/− button 42. Functionality surrounding some uses of the control panel is described below.

As shown in FIG. 5, an example display 44 includes an analog clock face 46, a digital clock face 48, an alarm icon 50, a lamp timer icon 52, a teaching game icon 64, and a snooze icon 66. Lamp timer icon 52 includes light bulb segment 54. Contained within said light bulb segment 54 is an x-shaped segment 56. Above and just to the left of the light bulb segment 54 is an ON segment 58. Immediately to the right of said ON segment 58, is an OFF segment 60. Directly right of light bulb segment 54 is a CNG segment 62. Functionality related to some portions of the example display is described below.

The flowchart in FIG. 6 illustrates one example of a ‘Program’ sequence 100. In at least one example, some buttons from the control panel 26 are used to program a state-changing lamp. Programming of the lamp is facilitated by related information which is indicated on the display 44. In implementations of this example, a user of the device initiates the sequence by pressing and holding the LIGHT button 32. Light bulb segment 54 appears in the display for the duration of the sequence. At the same time that light bulb segment 54 appears in the display, ON segment 58 appears and the ON time, that is to say the time at which the lamp will turn on in a first color, is displayed on digital clock face 48. The user may now adjust the ON time by using HOUR +/− button 40 and MINUTE +/-31 button 42, to adjust the hour and minute value respectively. Once satisfied the user taps LIGHT button 32 to proceed.

Next in the sequence of FIG. 6, ON segment 58 disappears and OFF segment 60 appears instead. An OFF time, that is to say the time at which the lamp will turn off entirely, is displayed on digital clock face 48. The user may now adjust the OFF time in a manner similar to how they just adjusted the ON time. Once satisfied the user taps LIGHT button 32 to proceed.

Last in the sequence of FIG. 6, OFF segment 60 disappears and CNG segment 62 appears instead. A CHANGE time, that is to say the time at which the lamp will change from a first color to a second color, is displayed on digital clock face 48. Logic automatically restricts values of the CHANGE time to fall within the window just defined by the ON and OFF times respectively. Furthermore, other logic allows the user to bypass the lamp change function and instead simply have said lamp turn on at the time defined by the ON time and turn off at the time defined by the OFF time. The override is affected by selecting the CHANGE time to be the same as either the ON time (in which case the lamp turns on in a first color at the ON time and turns off at the OFF time) or the OFF time (in which case the lamp turns on in a second color at the ON time and turns off at the OFF time). Once the user has selected a value for the CHANGE time, a final tap of LIGHT button 32 exits ‘Program’ sequence 100 and returns the device to an ordinary, real-time state in which a ‘run lamp timer’ sub-mode is automatically enacted.

The on/off/change sequence defined by the ‘Program’ sequence 100 repeats on a daily cycle, indefinitely, so long as the device is left in said ‘run lamp timer’ sub-mode. The user may choose to suspend the ‘run lamp timer’ sub-mode and instead leave the device in an alternate sub-mode during which the lamp is either on (in one or more colors) or off, indefinitely.

In some examples, the nature of the ‘Program’ sequence 100 may be achieved in other ways, via alternate controls or via a different sequence or type of interaction (i.e. by tapping, pressing-and-holding, etc.) with the same set of controls described above. Other functions of the device may also be manipulated using the same set of buttons which form the control panel 26.

In some examples, the device may incorporate other clock- and/or calendar-type features. These other features include, but are not limited to, items such as audible or visual alarm clock functions which cause the device to sound or otherwise indicate an alert one or more times per day or perhaps on a weekly, monthly or annual schedule. In addition, a snooze function may be incorporated. A radio, CD player, digital music file player (i.e. an MP3 player) or other means of music player may be incorporated.

In some examples, other features may be combined with the device. For example a teaching mode may be incorporated. The purpose of said teaching mode is to teach the association between the time told on the analog clock face 46 and the actual current time of day. Ways to accomplish this may include, but are not limited to, making use of the digital clock face 48 to create a call-and-response type activity designed to display first a time on the analog clock face 46 and then, subsequently (or possibly concurrently), a time on the digital clock face 48. Times displayed during the activity may be restricted in difficulty by creating various levels of play. For example, an easiest level may only show times that correspond to whole hours of the day (i.e. 11, 12, 1, etc.). A hardest level may show any time of day, without restriction (i.e. 11:04). Levels of moderate difficulty may restrict displayed times to show only whole and half-hour times (i.e. 11, 11:30, etc.) or any other restricted combination of times that would help further the purpose of the teaching lesson. Alone or in combination with the display, an audible voice may announce the time and/or other prompts to make the teaching lesson more meaningful, more fun, or both.

In some examples, a story-telling mode may be combined with the device whereby the device may be capable of playing back stories or other similar audio files either autonomously or in a “page-by-page” mode whereby inputs from the user (such as by pressing left button 18 and right button 20) cause the device to jump between sound snippets that correspond to a single section, page or other subset of the full story text.

In some examples, the sequence described above to be repeatable daily, may be repeatable for some other period of time such as weekly, monthly, or according to some other schedule altogether.

In some examples, animated sequences depicted on display 44, may accompany one or more functions of the device.

Other implementations are also within the scope of the following claims.

For example in another implementation, left button 18 and right button 20 may themselves illuminate, rather than or in addition to the illuminated bezels 22.

In another implementation, variations of the removable bezel 16 may be used in order to create various different device aesthetics. A completely different physical form altogether may be implemented, be that in plastic, metal, soft plush material or any other material, but it is understood that a change in the physical shape of the device would likely not affect the purpose or intent of the functional description or claims.

1. An apparatus comprising
a visible indicator to provide two or more effects that have a visible difference that can be understood by a child,
a controller to cause the visible indicator to provide a selected one or more of the effects at corresponding times to indicate when it is appropriate for a child to take an action.

2. The apparatus of claim 1 in which the visible indicator comprises a lamp that provides the two or more effects as two different colors of light.

3. The apparatus of claim 1 in which the action comprises the child getting out of bed.

4. The apparatus of claim 1 in which the controller comprises a clocking feature.

5. The apparatus of claim 4 in which the time measured by the clocking feature is displayed to the child as a clock.

6. The apparatus of claim 1 in which the difference comprises a difference in color effect.

7. The apparatus of claim 1 in which the controller can be programmed independently with respect to each of the effects.

8. The apparatus of claim 1 in which the controller provides a time-teaching function.

9. The apparatus of claim 8 in which the time-teaching function teaches time represented in analog form or digital form or both.

10. The apparatus of claim 1 in which the controller provides a night-light function.

11. The apparatus of claim 1 in which the controller provides an alarm clock function.

12. The apparatus of claim 1 comprising separate parent controls and child controls.

13. The apparatus of claim 12 in which the parent controls are concealed.

14. The apparatus of claim 1 comprising interchangeable components to alter a physical appearance of the apparatus.

15. The apparatus of claim 1 comprising elements that constitute the apparatus as a plush toy.

16. A method comprising
displaying a visible effect comprising one color of light from a lamp to a child who is in a bed, the one color of light being understood by the child as indicating that he should remain in the bed, and
at a time when it is appropriate for the child to get out of the bed, displaying another visible effect comprising a different color of light from the lamp that is understood by the child as indicating that he may get out of the bed.

17. The method of claim 16 in which the two visible effects may be programmed by a user independently of one another.

18. The method of claim 16 including teaching time to the child.

19. The method of claim 18 in which the time is taught in either or both of an analog and a digital format.

20. The method of claim 16 including at least one of (a) providing a night-light for the child, (b) providing an alarm, and (c) teaching time.
